(19) United States
(12) Patent Application Publication
(10) Pub. No.: US 2026/0290914 A1
(43) Pub. Date: Sep. 24, 2026

(54) BATTERY SYSTEM

(71) Applicant: HONDA MOTOR CO., LTD., Tokyo (JP)

(72) Inventors: Soichi MORII, Saitama (JP); Yasuo YAMADA, Saitama (JP); Tsukasa ITOH, Tokyo (JP)

(73) Assignee: HONDA MOTOR CO., LTD., Tokyo (JP)

(21) Appl. No.: 19/572,898

(22) Filed: Mar. 20, 2026

(30) Foreign Application Priority Data
Mar. 21, 2025 (JP) 2025-046867

(51) Int. Cl. H01M 10/42; B60L 50/60; H01M 50/204; H01M 50/249; H02J 7/50

(52) U.S. Cl. CPC H01M 10/425; B60L 50/60; H01M 50/204; H01M 50/249; H02J 7/575; H01M 2220/20

(57) ABSTRACT

A battery system has a battery and a controller. The battery includes a first power storage unit, a second power storage unit, and a connection switching circuit that switches between a series connection state and a parallel connection state. The connection switching circuit includes a series connection switch and a parallel connection switch. The controller includes a power source, a first control switch, and a second control switch. The power source supplies an operating current for turning the connection switch on. The first control switch opens and closes a current path from the power source to the series connection switch and the parallel connection switch. The second control switch switches between a first state where the series connection switch is connected to an output of the first control switch and a second state where the parallel connection switch is connected to the output of the first control switch.

### CROSS-REFERENCE TO RELATED APPLICATIONS

This application is based on and claims priority under 35 USC 119 from Japanese Patent Application No. 2025-046867 filed on Mar. 21, 2025, the entire content of which is incorporated herein by reference.

### TECHNICAL FIELD

The present disclosure relates to a battery system.

### BACKGROUND ART

In recent years, in order to allow more users to access affordable, reliable, sustainable, and advanced energy, researches and developments have been conducted on charging and power feeding in a vehicle equipped with a secondary battery that contributes to an increase in energy efficiency.

Charging equipment having different charging voltages depending on charging stations is provided for charging and power feeding in the vehicle equipped with a secondary battery. For example, there are two types of charging equipment corresponding to 400 V class and 800 V class. When a vehicle is compatible with only the charging equipment corresponding to 400 V class, the vehicle cannot enjoy quick charging performance of the charging equipment corresponding to 800 V class by the charging equipment corresponding to 800 V class.

In a case where the vehicle is both compatible with the charging equipment corresponding to 400 V class and 800 V class, generally, a voltage is boosted to 800 V by a voltage converter when charging by the charging equipment corresponding to 400 V class, or the voltage is stepped down to 400 V by the voltage converter when charging by the charging equipment corresponding to 800 V class. However, using such a voltage converter for charging deteriorates efficiency during charging.

In this regard, there is known a vehicle in which a connection method of battery modules is switched so as to be chargeable by both the charging equipment corresponding to 400 V class and the charging equipment corresponding to 800 V class without using any voltage converter for charging (for example, see JP2024-079278A and JP2024-115039A).

Such a battery of the vehicle is provided with a series connection switch that is in an on state when the battery modules are in a series connection state and is in an off state when the battery modules are in a parallel connection state, and a parallel connection switch that is in an on state when the battery modules are in a parallel connection state and is in an off state when the battery modules are in a series connection state, and by appropriately switching these switches, efficient charging is possible even when the charging voltage is different.

However, in a case where the parallel connection switch is unintentionally turned on when the battery modules are in the series connection state, or the series connection switch is unintentionally turned on when the battery modules are in the parallel connection state, the battery may be short-circuited.

### SUMMARY OF INVENTION

The present disclosure provides a battery system capable, by switching a connection method of battery modules, of charging even in cases of different charging voltages while preventing a short circuit of a battery.

An aspect of the present disclosure is a battery system having:
a battery including:
   a first power storage unit;
   a second power storage unit; and
   a connection switching circuit configured to switch between a series connection state where the first power storage unit and the second power storage unit are connected in series and a parallel connection state where the first power storage unit and the second power storage unit are connected in parallel; and
a controller configured to control the connection switching circuit, in which
the connection switching circuit includes:
   a series connection switch that is electrically operable, is in an on state in the series connection state, and is in an off state in the parallel connection state; and
   a parallel connection switch that is electrically operable, is in an off state in the series connection state, and is in an on state in the parallel connection state, and
the controller includes:
   a power source supplying, to the series connection switch and the parallel connection switch, an operating current for turning the series connection switch on and for turning the parallel connection switch on;
   a first control switch that opens and closes a current path from the power source to the series connection switch and the parallel connection switch; and
   a second control switch configured to switch between a first state where the series connection switch is connected to an output of the first control switch and a second state where the parallel connection switch is connected to the output of the first control switch.

According to the aspect of the present disclosure, it is possible to switch a connection method of battery modules while preventing a short circuit of the battery.

### BRIEF DESCRIPTION OF DRAWINGS

Exemplary embodiment(s) of the present invention will be described in detail based on the following figures, wherein:

FIG. 1 is a diagram showing an example of a charging system including a battery for illustrating an embodiment of the present disclosure;

FIG. 2 is a diagram showing a series connection state of the battery in FIG. 1;

FIG. 3 is a diagram showing a parallel connection state of the battery in FIG. 1;

FIG. 4 is a diagram showing a controller that controls a connection switching circuit of the battery in FIG. 1;

FIG. 5 is a diagram showing a configuration of the controller in the parallel connection state;

FIG. 6 is a diagram showing a configuration of the controller in the series connection state;

FIG. 7 is a diagram showing another example of the controller that controls the battery connection switching circuit in FIG. 1; and

FIG. 8 is a diagram showing in detail a control circuit of the controller in FIG. 4.

### DESCRIPTION OF EMBODIMENTS

An example of a charging system including a battery for illustrating an embodiment of the present disclosure will be described with reference to the accompanying drawings.

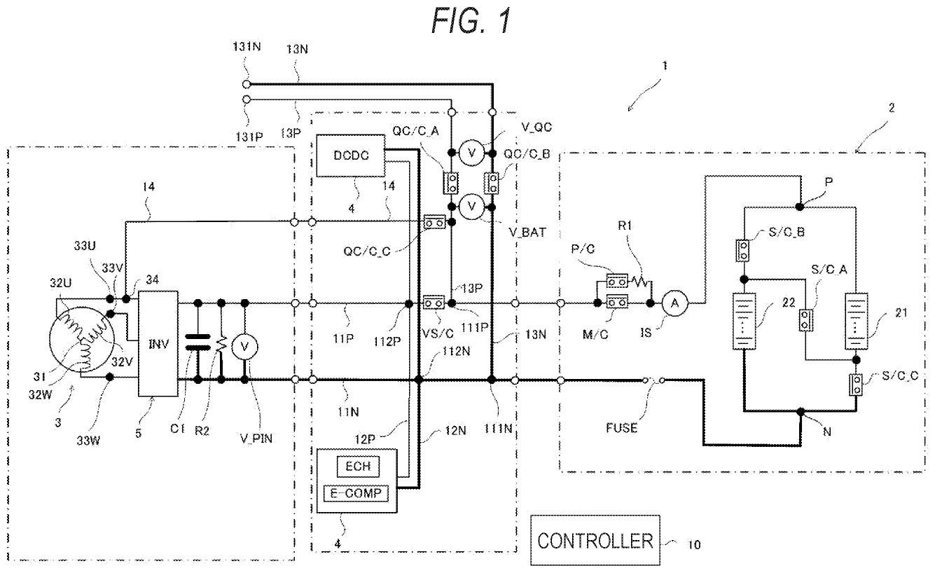

A charging system 1 shown in FIG. 1 is mounted on an electric vehicle such as an electric automobile. The charging system 1 includes a battery 2, a three-phase motor 3, an auxiliary device 4, an inverter 5 (PDU), electric power supply circuits 11P and 11N, auxiliary device drive circuits 12P and 12N, DC power supply circuits 13P and 13N, a branch circuit 14, and a controller 10.

As shown in FIGS. 1 to 3, the battery 2 includes a first power storage unit 21, a second power storage unit 22, first to fifth contactors M/C, S/C_A, S/C_B, S/C_C, P/C, a first resistor R1, a current sensor IS, and a current breaker FUSE. The first power storage unit 21 and the second power storage unit 22 are battery modules which can be charged and supply power at 400 V.

The first contactor M/C is provided on a positive electrode side end of the battery 2, and functions as a main switch which turns on and off connection to the outside (electric power supply circuit 11P) of the battery 2.

The second to fourth contactors S/C_A, S/C_B, and S/C_C constitute a connection switching circuit that switches a connection state between the first power storage unit 21 and the second power storage unit 22 between series connection and parallel connection. The second contactor S/C_A is provided at a midpoint of the series connection of the first power storage unit 21 and the second power storage unit 22. The third contactor S/C_B is arranged in parallel to a series circuit of the first power storage unit 21 and the second contactor S/C_A, and the fourth contactor S/C_C is arranged in parallel to a series circuit of the second contactor S/C_A and the second power storage unit 22.

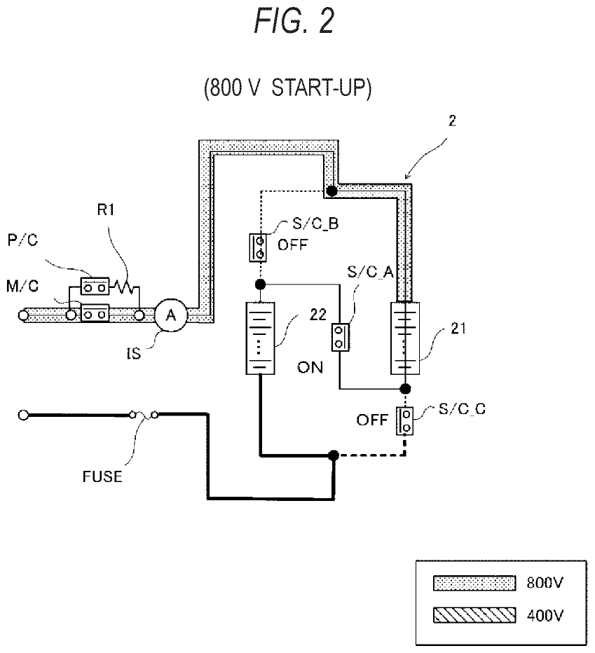

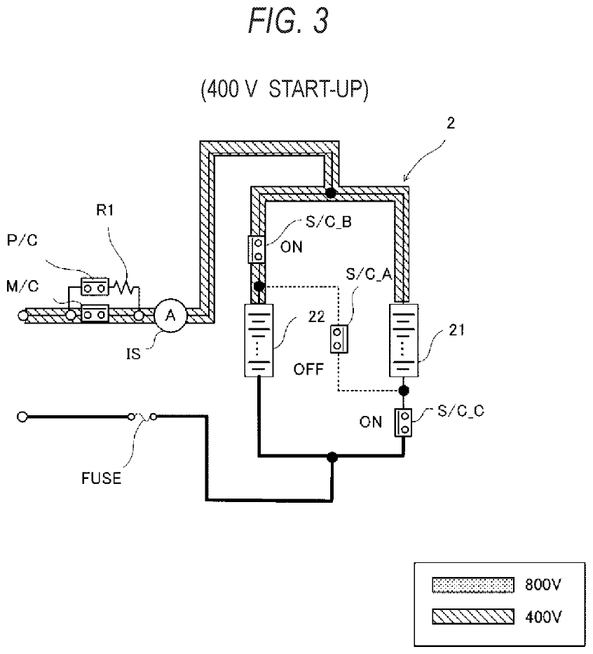

As shown in FIG. 2, when the second contactor S/C_A is turned on and the third contactor S/C_B and the fourth contactor S/C_C are turned off, the battery 2 gets to a series connection state (800 V start-up), in which the first power storage unit 21 and the second power storage unit 22 are connected in series, and can be charged and supply power at 800 V. As shown in FIG. 3, when the second contactor S/C_A is turned off, and the third contactor S/C_B and the fourth contactor S/C_C are turned on, the battery 2 gets to a parallel connection state (400 V start-up), in which the first power storage unit 21 and the second power storage unit 22 are connected in parallel, and can be charged and supply power at 400 V. Note that the term “start-up” refers to a concept including driving during traveling of an electric vehicle including the charging system 1 and charging during parking of the electric vehicle.

The fifth contactor P/C and the first resistor R1 are arranged in series with each other and in parallel with the first contactor M/C. In the series connection state and the parallel connection state, the fifth contactor P/C is turned on before the first contactor M/C is turned on, thereby protecting the first contactor M/C from an excessive inrush current.

The current sensor IS is disposed between the first contactor M/C and the first power storage unit 21 and the second power storage unit 22.

The current breaker FUSE is disposed on a negative electrode side end of the battery 2 and cuts off the connection to the outside (electric power supply circuit 11N) of the battery 2 when an abnormality occurs. In the charging system 1 according to the present embodiment, the current breaker FUSE is implemented by a pyro-fuse which can intentionally cut off a current according to an electrical signal. When an abnormality (for example, vehicle collision or a short circuit in the battery 2) occurs, the current breaker FUSE is operated to cut off, and all the contactors in the battery 2 are turned off (opened).

The three-phase motor 3 includes coils of three phases 32U, 32V, and 32W, one end side of each of which is connected to a neutral point 31, and is rotationally driven by electric power supplied from the battery 2 via the inverter 5. The three-phase motor 3 in the present embodiment includes a U-phase terminal 33U, a V-phase terminal 33V, and a W-phase terminal 33W connected to the other end side of each of the coils 32U, 32V, and 32W, respectively. The U-phase terminal 33U, the V-phase terminal 33V, and the W-phase terminal 33W are connected to the inverter 5. The other end side of a coil of any one phase among the coils 32U, 32V, and 32W is connected to the branch circuit 14 at a connection portion 34. In the present embodiment, the U-phase coil 32U among the coils of the three phases 32U, 32V, and 32W is connected to the branch circuit 14 at the connection portion 34 positioned between the U-phase terminal 33U and the inverter 5.

The inverter 5 converts DC electric power supplied from the battery 2 to three-phase AC electric power by switching of a plurality of switching elements, so as to rotationally drive the three-phase motor 3. When a DC current (400 V) is supplied from the branch circuit 14 to the connection portion 34, the inverter 5 can function as a booster circuit (DC voltage conversion unit) to boost the DC current using the coil connected to the branch circuit 14 and the coil of another one phase or another two phases, by the switching of the plurality of switching elements.

The auxiliary device 4 is an in-vehicle device that can be driven by DC electric power from the battery 2 and an external power source, and includes, for example, an electric compressor E-COMP for an air conditioner (A/C), an electric heater ECH, and a converter DCDC for an auxiliary device. The electric compressor E-COMP and the electric heater ECH are high-voltage drive in-vehicle devices, and the converter DCDC for an auxiliary device steps down DC electric power from the battery 2 and an external power source to drive low-voltage drive in-vehicle devices. The auxiliary device 4 is connected to the battery 2 via the auxiliary device drive circuits 12P and 12N, a sixth contactor VS/C, and the electric power supply circuits 11P and 11N. The auxiliary device 4 of the present embodiment is operated at a base voltage of 800 V while the vehicle is traveling. On the other hand, the auxiliary device 4 is capable of operating even when the voltage is not 800 V, and is configured to operate by being boosted to an efficient drive voltage during charging at 400 V described later.

The electric power supply circuits 11P and 11N are configured as a positive and negative pair and connect the battery 2 and the inverter 5 (three-phase motor 3). The electric power supply circuits 11P and 11N are provided with connection portions 111P and 111N connected to the DC power supply circuits 13P and 13N and are provided with connection portions 112P and 112N connected to the auxiliary device drive circuits 12P and 12N (auxiliary device 4) on a side closer to the inverter 5 than the connection portions 111P and 111N. The electric power supply circuit 11P at a positive electrode side is provided with the sixth contactor VS/C which turns on/off the circuit between the connection portion 112P connected to the auxiliary device drive circuit 12P and the connection portion 111P of the DC power supply circuit 13P. A first voltage sensor V_PIN, a first smoothing capacitor C1, and a second resistor R2 are provided on the inverter 5 side of the electric power supply circuits 11P and 11N. The first voltage sensor V_PIN, the first smoothing capacitor C1, and the second resistor R2 are provided on a circuit that connects the electric power supply circuit 11P at the positive electrode side and the electric power supply circuit 11N at a negative electrode side. Note that the second resistor R2 is provided to cause the first smoothing capacitor C1 to supply power when the circuit is cut off.

The DC power supply circuits 13P and 13N are configured as a positive and negative pair and include one end provided with charging terminals 131P and 131N to which an external power source such as charging equipment can be connected and the other end connected to the electric power supply circuits 11P and 11N via the connection portions 111P and 111N. The DC power supply circuits 13P and 13N are provided with a seventh contactor QC/C_A and an eighth contactor QC/C_B for turning on/off the circuits, respectively. A second voltage sensor V_BAT is provided at a position closer to the connection portions 111P and 111N than the seventh contactor QC/C_A and the eighth contactor QC/C_B. A third voltage sensor V_QC is provided at a position closer to the charging terminals 131P and 131N than the seventh contactor QC/C_A and the eighth contactor QC/C_B.

The branch circuit 14 is branched, in the DC power supply circuit 13P at the positive electrode side, at a position closer to the connection portion 111P than the eighth contactor QC/C_A and the second voltage sensor V_BAT, and is connected to one of the coils of the three-phase motor 3 via the connection portion 34. An intermediate portion of the branch circuit 14 is provided with a ninth contactor QC/C_C for turning on/off the circuit.

The controller 10 is, for example, a vehicle ECU and controls driving and charging of the charging system 1. More specifically, the controller 10 performs an ON/OFF control of the contactors M/C, S/C_A, S/C_B, S/C_C, P/C, VS/C, QC/C_A, QC/C_B, and QC/C_C, detection of welding of these contactors, control of the inverter 5, and the like.

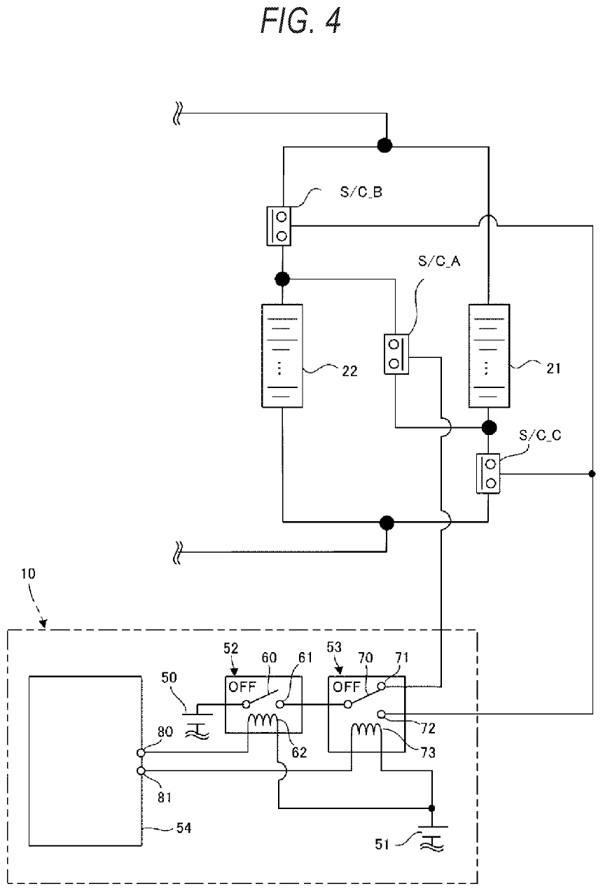

FIG. 4 shows the controller of the connection switching circuit, which switches between the series connection state and the parallel connection state of the battery 2.

The second contactor S/C_A, the third contactor S/C_B, and the fourth contactor S/C_C, which constitute the connection switching circuit, are all electrically operable, are in an on state while an operating current is supplied, and are automatically turned off when the supply of the operating current is cut off. Such contactors typically include a movable contact, a fixed contact, an electromagnet that magnetically attracts the movable contact toward the fixed contact, and a spring that biases the movable contact away from the fixed contact. When the operating current is supplied to the electromagnet, the movable contact magnetically attracted to the electromagnet comes into contact with the fixed contact, and is turned on, and when the supply of the operating current is cut off, the movable contact, which is biased by the spring, moves away from the fixed contact and is turned off.

The controller 10 includes a first power source 50, a second power source 51, a first control switch 52, a second control switch 53, and a control circuit 54. The first power source 50 supplies the operating current to the second contactor S/C_A, the third contactor S/C_B, and the fourth contactor S/C_C. The first control switch 52 and the second control switch 53 are electrically operable, and the second power source 51 supplies the operating current to the first control switch 52 and the second control switch 53. The first power source 50 and the second power source 51 may be the same power source or different power sources. The electrically operable first control switch 52 and the electrically operable second control switch 53 are, for example, relay switches.

The first control switch 52 opens and closes a current path from the first power source 50 to the second contactor S/C_A, the third contactor S/C_B, and the fourth contactor S/C_C. The first control switch 52 includes a movable contact 60, a fixed contact 61, an electromagnet 62 that magnetically attracts the movable contact 60, and a spring (not shown) that biases the movable contact 60 in a direction opposite to a direction in which the electromagnet 62 attracts the movable contact 60. The movable contact 60 is electrically connected to the first power source 50.

When the first control switch 52 is in an on state, that is, when the operating current is supplied from the second power source 51 to the electromagnet 62, the electromagnet 62 magnetically attracts the movable contact 60, and the magnetically attracted movable contact 60 comes into contact with the fixed contact 61, thereby closing the current path from the first power source 50 to the second contactor S/C_A and the like. When the first control switch 52 is turned off by cutting off the supply of the operating current to the electromagnet 62, the movable contact 60, which is biased by a spring, moves away from the fixed contact 61, thereby opening the current path from the first power source 50 to the second contactor S/C_A and the like.

The second control switch 53 is disposed between the first control switch 52 and the second contactor S/C_A, third contactor S/C_B, and fourth contactor S/C_C. The second control switch 53 is switchable between a first state where the second contactor S/C_A is connected to an output of the first control switch 52, and a second state where the third contactor S/C_B and the fourth contactor S/C_C are connected to the output of the first control switch 52.

The second control switch 53 includes a movable contact 70, a first fixed contact 71, a second fixed contact 72, an electromagnet 73 that magnetically attracts the movable contact 70, and a spring (not shown) that biases the movable contact 70 in a direction opposite to a direction in which the electromagnet 73 attracts the movable contact 70. The movable contact 70 is electrically connected to the fixed contact 61, which is the output of the first control switch 52. The first fixed contact 71 is electrically connected to the second contactor S/C_A, and the second fixed contact 72 is electrically connected to the third contactor S/C_B and the fourth contactor S/C_C. The first fixed contact 71 and the second fixed contact 72 are spaced apart in the direction in which the electromagnet 73 attracts the movable contact 70, and the movable contact 70 is disposed between the first fixed contact 71 and the second fixed contact 72.

The control circuit 54 includes a first control terminal 80 and a second control terminal 81. The first control terminal 80 is electrically connected to one end of a coil of the electromagnet 62 of the first control switch 52, and the second control terminal 81 is electrically connected to one end of a coil of the electromagnet 73 of the second control switch 53. When the first control terminal 80 is connected to ground within the control circuit 54, a current flows from the second power source 51 to the first control terminal 80, and the operating current is supplied to the electromagnet 62 of the first control switch 52. Similarly, when the second control terminal 81 is connected to ground within the control circuit 54, a current flows from the second power source 51 to the second control terminal 81, and the operating current is supplied to the electromagnet 73 of the second control switch 53. The control circuit 54 is configured to control the connection between the first control terminal 80 and ground and the connection between the second control terminal 81 and ground depending on a usage state of the electric vehicle, such as a state where the electric vehicle travels when the battery 2 is started up at 800 V and a state where the electric vehicle is charged when the battery 2 is started up at 400 V.

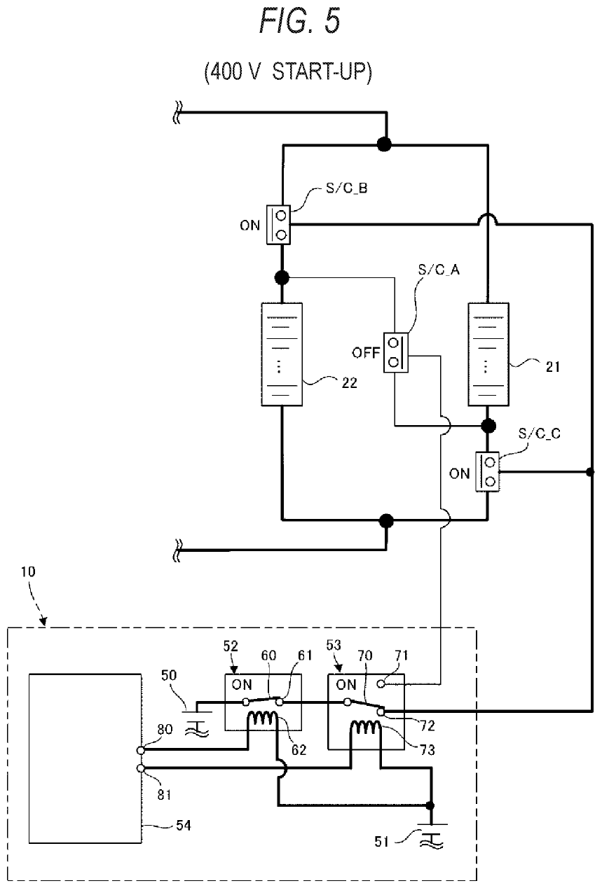

FIG. 5 shows a circuit configuration of the controller 10 at 400 V start-up. The operating current is supplied from the second power source 51 to the electromagnet 62 of the first control switch 52, and the first control switch 52 is in the on state. The operating current is also supplied from the second power source 51 to the electromagnet 73 of the second control switch 53, and the second control switch 53 is also in the on state. The electromagnet 73 magnetically attracts the movable contact 70, and the magnetically attracted movable contact 70 moves away from the first fixed contact 71 and comes into contact with the second fixed contact 72.

The current path from the first power source 50 to the third contactor S/C_B and the fourth contactor S/C_C is established, and the operating current is supplied to the third contactor S/C_B and the fourth contactor S/C_C. On the other hand, the current path from the first power source 50 to the second contactor S/C_A is cut off, and the supply of the operating current to the second contactor S/C_A is cut off. The second contactor S/C_A is in the off state, the third contactor S/C_B and the fourth contactor S/C_C are in the on state, and the battery 2 is started up at 400 V with the first power storage unit 21 and the second power storage unit 22 connected in parallel.

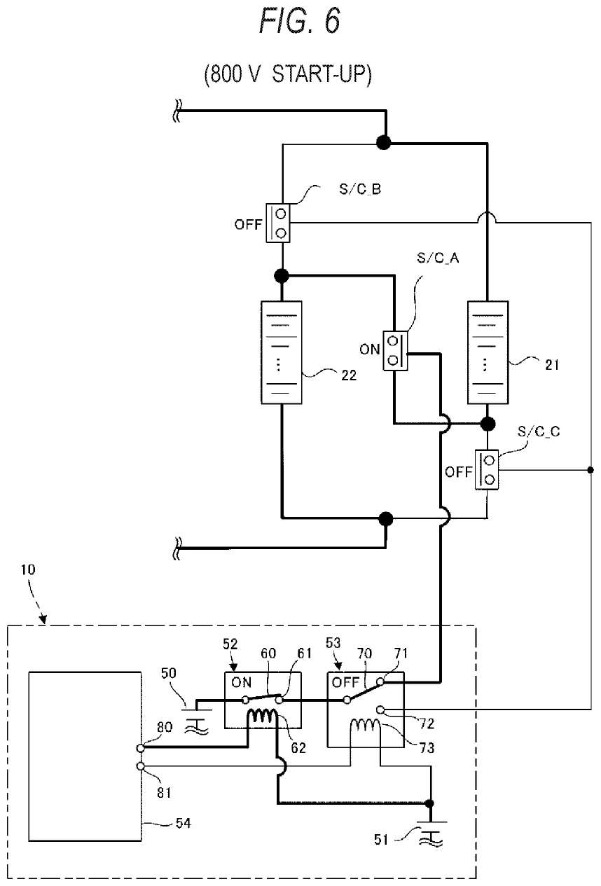

FIG. 6 shows a circuit configuration of the controller 10 at 800 V start-up. The operating current is supplied from the second power source 51 to the electromagnet 62 of the first control switch 52, and the first control switch 52 is in the on state. On the other hand, the supply of the operating current from the second power source 51 to the electromagnet 73 of the second control switch 53 is cut off, and the second control switch 53 is in the off state. The movable contact 70, which is released from the magnetic attraction by the electromagnet 73, moves away from the second fixed contact 72 and comes into contact with the first fixed contact 71.

The current path from the first power source 50 to the second contactor S/C_A is established, and the operating current is supplied to the second contactor S/C_A. On the other hand, the current path from the first power source 50 to the third contactor S/C_B and the fourth contactor S/C_C is cut off, and the supply of the operating current to the third contactor S/C_B and the fourth contactor S/C_C is cut off. The second contactor S/C_A is in the on state, the third contactor S/C_B and the fourth contactor S/C_C are in the off state, and the battery 2 is started up at 800 V with the first power storage unit 21 and the second power storage unit 22 connected in series.

In this way, the second control switch 53 exclusively establishes one of the current path from the first power source 50 to the second contactor S/C_A and the current path from the first power source 50 to the third contactor S/C_B and the fourth contactor S/C_C, and physically cuts off the other path. Accordingly, the second contactor S/C_A and the third contactor S/C_B and the fourth contactor S/C_C can be prevented from being all in the on state, thereby preventing a short circuit in the battery 2.

When switching from the 400 V start-up to the 800 V start-up, or from the 800 V start-up to the 400 V start-up, the control circuit 54 first turns the first control switch 52 off to open the current path from the first power source 50 to the second contactor S/C_A and the like. In this state, the control circuit 54 switches the second control switch 53. Then, after the switching of the second control switch 53 is complete, the control circuit 54 turns the first control switch 52 on to close the current path from the first power source 50 to the second contactor S/C_A and the like, and the switching from the 400 V start-up to the 800 V start-up or from the 800 V start-up to the 400 V start-up is complete.

When the current path from the first power source 50 to the second contactor S/C_A and the like is open, no voltage is applied between the movable contact 70 and the first fixed contact 71 and the second fixed contact 72 of the second control switch 53, and by switching the second control switch 53 in this state, it is possible to prevent an arc from occurring between the contacts. Accordingly, it is possible to prevent a matter that the movable contact 70 sticks to the first fixed contact 71 or the second fixed contact 72, making it impossible to switch the second control switch 53.

For example, assuming the 800 V start-up when traveling and the 400 V start-up or 800 V start-up when charging, the second control switch 53 is preferably configured to establish the current path from the first power source 50 to the second contactor S/C_A when the second control switch 53 is in an off state, and to establish the current path to the third contactor S/C_B and the fourth contactor S/C_C when the second control switch 53 is in an on state, that is, is preferably set to the 800 V start-up when traveling in the off state, and set to the 400 V start-up when in the on state. Accordingly, an output voltage of the battery 2 can be set to a traveling voltage simply by operating the first control switch 52. Even if a signal to turn the second control switch 53 on is not received by the second control switch 53, the second control switch 53 is in the off state and set to the 800 V start-up, and even if the second control switch 53 is stuck in the off state, the second control switch 53 is still set to the 800 V start-up, and thus the electric vehicle can travel and be charged, and an occupant of the electric vehicle can take appropriate action, such as moving to a safe location. On the other hand, if the second control switch 53 is stuck in the on state, it is assumed that the 400 V start-up is set, and the vehicle is essentially parked in a safe location during or immediately after charging, ensuring the safety of the occupant.

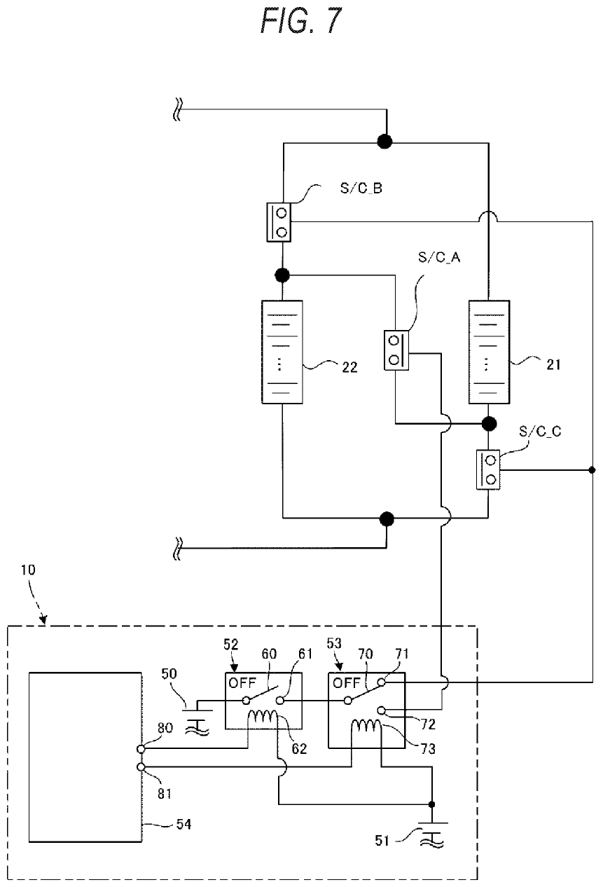

Note that setting may be the 400 V start-up when traveling and the 400 V start-up or 800 V start-up when charging, and in this case, as shown in FIG. 7, the second control switch 53 is preferably configured to establish the current path to the third contactor S/C_B and the fourth contactor S/C_C when the second control switch 53 is in the off state, and to establish the current path from the first power source 50 to the second contactor S/C_A when the second control switch 53 is in the on state, that is, is preferably set to the 400 V start-up when traveling in the off state, and set to the 800 V start-up when in the on state.

The first control switch 52 is preferably configured to open the current path from the first power source 50 to the second contactor S/C_A when the first control switch 52 is in the off state, and close the current path from the first power source 50 to the second contactor S/C_A when the first control switch 52 is in the on state. Even if the first control switch 52 is stuck in the off state, the electric vehicle is assumed to be parked in a safe location, ensuring the safety of the occupant. If the first control switch 52 is stuck in the on state, the electric vehicle can travel, and the occupant of the electric vehicle can take action, such as moving to a safe location.

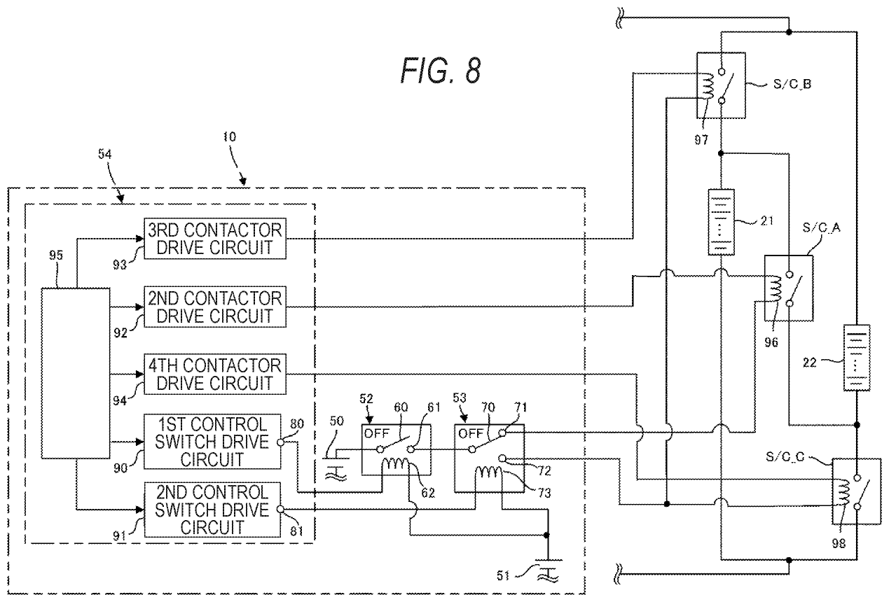

FIG. 8 shows details of the control circuit 54. The control circuit 54 includes a first control switch drive circuit 90, a second control switch drive circuit 91, a second contactor drive circuit 92, a third contactor drive circuit 93, a fourth contactor drive circuit 94, and a processor 95 that controls these drive circuits 90 to 94.

The first control switch drive circuit 90 includes the first control terminal 80 electrically connected to one end of the coil of the electromagnet 62 of the first control switch 52, and a switch element capable of connecting the first control terminal 80 to ground. The switch element connects and disconnects the first control terminal 80 to and from ground in accordance with a control signal received from the processor 95. As described above, the first control terminal 80 is connected to ground, so that a current flows from the second power source 51 to the first control terminal 80, the operating current is supplied to the electromagnet 62 of the first control switch 52, and the first control switch 52 is turned on.

The second control switch drive circuit 91 includes the second control terminal 81 electrically connected to one end of the coil of the electromagnet 73 of the second control switch 53, and a switch element capable of connecting the second control terminal 81 to ground. The switch element connects and disconnects the second control terminal 81 to and from ground in accordance with a control signal received from the processor 95. As described above, when the second control terminal 81 is connected to ground, the current flows from the second power source 51 to the second control terminal 81, the operating current is supplied to the electromagnet 73 of the second control switch 53, and the second control switch 53 is turned on.

The second contactor drive circuit 92 is electrically connected to one end of a coil of an electromagnet 96 of the second contactor S/C_A. The second contactor drive circuit 92 includes a switch element capable of connecting the coil of the electromagnet 96 of the second contactor S/C_A to ground, and the switch element connects and disconnects the coil to and from ground according to a control signal received from the processor 95. When the first control switch 52 is in the on state, the second control switch 53 is in the off state, and the operating current can be supplied to the electromagnet 96 of the second contactor S/C_A, one end of the coil of the electromagnet 96 of the second contactor S/C_A is connected to ground, so that the current flows from the first power source 50 to the second contactor drive circuit 92, the operating current is supplied to the electromagnet 96 of the second contactor S/C_A, and the second contactor S/C_A is turned on.

The third contactor drive circuit 93 is electrically connected to one end of a coil of an electromagnet 97 of the third contactor S/C_B. The third contactor drive circuit 93 includes a switch element capable of connecting the coil of the electromagnet 97 of the third contactor S/C_B to ground, and the switch element connects and disconnects the coil to and from ground according to a control signal received from the processor 95. When the first control switch 52 and the second control switch 53 are in the on state and the operating current can be supplied to the electromagnet 97 of the third contactor S/C_B, one end of the coil of the electromagnet 97 of the third contactor S/C_B is connected to ground, so that the current flows from the first power source 50 to the third contactor drive circuit 93, the operating current is supplied to the electromagnet 97 of the third contactor SC_B, and the third contactor S/C_B is turned on.

The fourth contactor drive circuit 94 is electrically connected to one end of a coil of an electromagnet 98 of the fourth contactor S/C_C. The fourth contactor drive circuit 94 includes a switch element capable of connecting the coil of the electromagnet 98 of the fourth contactor S/C_C to ground, and the switch element connects and disconnects the coil to and from ground according to a control signal received from the processor 95. When the first control switch 52 and the second control switch 53 are in the on state, and the operating current can be supplied to the electromagnet 98 of the fourth contactor S/C_C, one end of the coil of the electromagnet 98 of the fourth contactor S/C_C is connected to ground, so that the current flows from the first power source 50 to the fourth contactor drive circuit 94, the operating current is supplied to the electromagnet 98 of the fourth contactor S/C_C, and the fourth contactor S/C_C is turned on.

The first control switch drive circuit 90, the second control switch drive circuit 91, the second contactor drive circuit 92, the third contactor drive circuit 93, and the fourth contactor drive circuit 94 are provided independently of each other. Accordingly, unintended switching of the connection and settings of the connection switching circuit can be more reliably prevented.

For example, a case is considered in which an erroneous signal is input to the first control switch drive circuit 90 when the first control switch 52 and the second control switch 53 are in the off state, causing the first control switch 52 to be unintentionally turned on. In this case, the first control switch 52 is in the on state and the second control switch 53 is in the off state, the operating current can be supplied to the electromagnet 96 of the second contactor S/C_A, but whether the operating current is supplied to the electromagnet 96 of the second contactor S/C_A is controlled by the second contactor drive circuit 92. Accordingly, the connection switching circuit can be prevented from being unintentionally connected at 800 V start-up.

A case is considered in which an erroneous signal is input to the second control switch drive circuit 91 when the first control switch 52 is in the on state and the second control switch 53 is in the off state, causing the second control switch 53 to be unintentionally turned on. In this case, the first control switch 52 and the second control switch 53 are in the on state, the operating current can be supplied to the electromagnets 97 and 98 of the third contactor S/C_B and the fourth contactor S/C_C, but whether the operating current is supplied to the electromagnets 97 and 98 of the third contactor S/C_B and the fourth contactor S/C_C is controlled by the third contactor drive circuit 93 and the fourth contactor drive circuit 94. Accordingly, the connection switching circuit can be prevented from unintentionally switching from the 800 V start-up to the 400 V start-up.

The embodiment of the present disclosure has been described above, but the present invention is not limited to the embodiment described above, and modifications, improvements, and the like can be made as appropriate. In the present description, at least the following matters are described. Although corresponding constituent elements or the like in the above-described embodiments are shown in parentheses, the present invention is not limited thereto.
(1) A battery system having:
a battery (battery 2) including:
   a first power storage unit (first power storage unit 21);
   a second power storage unit (second power storage unit 22); and
   a connection switching circuit configured to switch between a series connection state where the first power storage unit and the second power storage unit are connected in series and a parallel connection state where the first power storage unit and the second power storage unit are connected in parallel; and
a controller (controller 10) configured to control the connection switching circuit, in which
the connection switching circuit includes:
   a series connection switch (second contactor S/C_A) that is electrically operable, is in an on state in the series connection state, and is in an off state in the parallel connection state; and
   a parallel connection switch (third contactor S/C_B and fourth contactor S/C_C) that is electrically operable, is in an off state in the series connection state, and is in an on state in the parallel connection state, and
the controller includes:
   a power source (first power source 50) supplying, to the series connection switch and the parallel connection switch, an operating current for turning the series connection switch on and for turning the parallel connection switch on;
   a first control switch (first control switch 52) that opens and closes a current path from the power source to the series connection switch and the parallel connection switch; and
   a second control switch (second control switch 53) configured to switch between a first state where the series connection switch is connected to an output of the first control switch and a second state where the parallel connection switch is connected to the output of the first control switch.

According to the battery system in the above (1), the second control switch can establish one of the current path from the power source to the series connection switch and the current path from the power source to the parallel connection switch, and can cut off the other current path. Accordingly, it is possible to avoid a situation in which the series connection switch and the parallel connection switch are both in the on state, and it is possible to prevent a short circuit from occurring in the battery.
(2) The battery system according to the above (1), in which
the first control switch and the second control switch are electrically operable relay switches.

According to the battery system in the above (2), the current path to be cut off by the second control switch can be physically cut off, and it is possible to prevent the short circuit from occurring in the battery.
(3) The battery system according to the above (1) or (2), in which
the controller further includes a control circuit (control circuit 54) that controls opening and closing of the first control switch and switching of the second control switch between the first state and the second state, and
the control circuit switches a state of the second control switch in a state where the first control switch is open.

According to the battery system in the above (3), when the state of the second control switch is switched, it is possible to prevent an arc from occurring between contacts of the second control switch. Accordingly, it is possible to prevent the contacts of the second control switch from sticking, and prevent the second control switch from being unable to be switched.
(4) The battery system according to any one of the above (1) to (3), in which
the second control switch is in the first state when the second control switch is in an off state, and is in the second state when the second control switch is in an on state.

According to the battery system in the above (4), the safety of an occupant can be ensured in both cases where the second control switch is stuck in the off state and where the second control switch is stuck in the on state.
(5) The battery system according to any one of the above (1) to (3), in which
the first control switch opens the current path when the first control switch is in an off state, and closes the current path when the first control switch is in an on state.

According to the battery system in the above (5), the safety of the occupant can be ensured in both cases where the first control switch is stuck in the off state and where the first control switch is stuck in the on state.
(6) The battery system according to any one of the above (1) to (3), in which
electric power is supplied to a drive source (three-phase motor 3) of a vehicle,
the battery outputs an operating voltage of the drive source in the series connection state, and
the second control switch is in the first state when the second control switch is in an off state, and is in the second state when the second control switch is in an on state.

According to the vehicle in the above (6), the voltage output from the battery can be set to the operating voltage of the drive source, that is, a vehicle traveling voltage, simply by operating the first control switch. Even if the signal to turn on the second control switch is not received by the second control switch or the second control switch is stuck in the off state, the vehicle can still travel.
(7) The battery system according to any one of the above (1) to (3), in which
electric power is supplied to a drive source (three-phase motor 3) of a vehicle,
the battery outputs an operating voltage of the drive source in the parallel connection state, and
the second control switch is in the second state when the second control switch is in an off state, and is in the first state when the second control switch is in an on state.

According to the battery system in the above (7), the voltage output from the battery can be set to the operating voltage of the drive source, that is, the vehicle traveling voltage, simply by operating the first control switch. Even if the signal to turn on the second control switch is not received by the second control switch or the second control switch is stuck in the off state, the vehicle can still travel.
(8) The battery system according to the above (1), in which
the controller further includes:
   a first control switch drive circuit that drives the first control switch;
   a second control switch drive circuit that drives the second control switch;
   a series connection switch drive circuit that drives the series connection switch, in a state where the operating current is allowed to be supplied to the series connection switch; and
   a parallel connection switch drive circuit that drives the parallel connection switch, in a state where the operating current is allowed to be supplied to the parallel connection switch, and
the first control switch drive circuit, the second control switch drive circuit, the series connection switch drive circuit, and the parallel connection switch drive circuit are independent of each other.

According to the battery system in the above (8), unintended switching of the connection and settings of the connection switching circuit can be more reliably prevented.

What is claimed is:

1. A battery system comprising:
a battery including:
a first power storage unit;
a second power storage unit; and
a connection switching circuit configured to switch between a series connection state where the first power storage unit and the second power storage unit are connected in series and a parallel connection state where the first power storage unit and the second power storage unit are connected in parallel; and
a controller configured to control the connection switching circuit, wherein
the connection switching circuit includes:
a series connection switch that is electrically operable, is in an on state in the series connection state, and is in an off state in the parallel connection state; and
a parallel connection switch that is electrically operable, is in an off state in the series connection state, and is in an on state in the parallel connection state, and
the controller includes:
a power source supplying, to the series connection switch and the parallel connection switch, an operating current for turning the series connection switch on and for turning the parallel connection switch on;
a first control switch that opens and closes a current path from the power source to the series connection switch and the parallel connection switch; and
a second control switch configured to switch between a first state where the series connection switch is connected to an output of the first control switch and a second state where the parallel connection switch is connected to the output of the first control switch.

2. The battery system according to claim 1, wherein
the first control switch and the second control switch are electrically operable relay switches.

3. The battery system according to claim 1, wherein
the controller further includes a control circuit that controls opening and closing of the first control switch and switching of the second control switch between the first state and the second state, and
the control circuit switches a state of the second control switch in a state where the first control switch is open.

4. The battery system according to claim 1, wherein
the second control switch is in the first state when the second control switch is in an off state, and is in the second state when the second control switch is in an on state.

5. The battery system according to claim 1, wherein
the first control switch opens the current path when the first control switch is in an off state, and closes the current path when the first control switch is in an on state.

6. The battery system according to claim 1, wherein
electric power is supplied to a drive source of a vehicle,
the battery outputs an operating voltage of the drive source in the series connection state, and
the second control switch is in the first state when the second control switch is in an off state, and is in the second state when the second control switch is in an on state.

7. The battery system according to claim 1, wherein
electric power is supplied to a drive source of a vehicle,
the battery outputs an operating voltage of the drive source in the parallel connection state, and
the second control switch is in the second state when the second control switch is in an off state, and is in the first state when the second control switch is in an on state.

8. The battery system according to claim 1, wherein
the controller further includes:
a first control switch drive circuit that drives the first control switch;
a second control switch drive circuit that drives the second control switch;
a series connection switch drive circuit that drives the series connection switch, in a state where the operating current is allowed to be supplied to the series connection switch; and
a parallel connection switch drive circuit that drives the parallel connection switch, in a state where the operating current is allowed to be supplied to the parallel connection switch, and
the first control switch drive circuit, the second control switch drive circuit, the series connection switch drive circuit, and the parallel connection switch drive circuit are independent of each other.
